(19) United States
(12) Patent Application Publication
(10) Pub. No.: US 2009/0032465 A1
(43) Pub. Date: Feb. 5, 2009

(54) METHOD FOR THE ELIMINATION OF METAL COMPLEX CATALYSTS FROM TELOMERIZATION MIXTURES

(75) Inventors: Goetz Baumgarten, Haltern am See (DE); Dagmara Ortmann, Brig-Glis (CH); Franz-Felix Kuppinger, Marl (DE); Cornelia Borgmann, Frankfurt (DE); Stephan Houbrechts, Duffel (BE)

Correspondence Address: OBLON, SPIVAK, MCCLELLAND MAIER & NEUSTADT, P.C., 1940 DUKE STREET, ALEXANDRIA, VA, 22314, US

(73) Assignee: Evonik Oxeno GmbH, Marl (DE)

(21) Appl. No.: 12/159,957

(22) PCT Filed: Dec. 7, 2006
(86) PCT No.: PCT/EP06/69401

§ 371 Date: Jul. 2, 2008

(30) Foreign Application Priority Data
Jan. 26, 2006 (DE) 102006003618.2

(51) Int. Cl. B01D 61/02

(52) U.S. Cl. 210/637; 210/652; 210/654

(57) ABSTRACT

Process for separating a metal complex catalyst from a reaction mixture obtained from a telomerization reaction, wherein the metal complex catalyst is separated off at least one membrane which is more permeable to the telomerization product than to the metal complex catalyst.

The present invention relates to a process for separating metal complex catalysts from reaction mixtures obtained in telomerization.

The telomerization of acyclic olefins having at least two conjugated double bonds, in particular the preparation of 1-octa-2,7-dienyl derivatives by reaction of a 1,3-butadiene-containing hydrocarbon mixture, in particular cracking C₄, with nucleophiles is a reaction which has frequently been described and studied in recent times.

The telomerization products formed from two mol of 1,3-butadiene and one mol of nucleophile (unsaturated amines, unsaturated alcohols and their unsaturated esters and unsaturated ethers) are starting materials for organic syntheses. The oxygen-containing derivatives are precursors for the preparation of linear C₈-alcohols and C₈-olefins, in particular 1-octanol and 1-octene. 1-Octanol is in turn used, for example, for producing plasticizers. 1-Octene is a sought-after comonomer for the modification of polyethylene and polypropylene.

The telomerization of butadiene with a nucleophile to give octadienyl derivatives is catalyzed by metal complexes, in particular palladium compounds.

Examples of telomerization reactions are described, inter alia, in E. J. Smutny, J. Am. Chem. Soc. 1967, 89, 6793; S. Takahashi, T. Shibano, N. Hagihara, Tetrahedron Lett. 1967, 2451; EP 0 561 779, U.S. Pat. No. 3,499,042, U.S. Pat. No. 3,530,187, GB 1 178 812, GB 1 248 593, U.S. Pat. No. 3,670,029, U.S. Pat. No. 3,670,032, U.S. Pat. No. 3,769,352, U.S. Pat. No. 3,887,627, GB 1 354 507, DE 20 40 708, U.S. Pat. No. 4,142,060, U.S. Pat. No. 4,146,738, U.S. Pat. No. 4,196,135, GB 1 535 718, U.S. Pat. No. 4,104,471, DE 21 61 750 and EP 0 218 100.

In DE 195 23 335, the catalyst system is separated off by reaction of the catalyst system with a water-soluble ligand and subsequent extraction with a hexane/water mixture, in which the telomerization product is obtained in the hexane phase and the catalyst is obtained in the aqueous phase.

EP 0 561 779 describes the separation of the catalyst by distillation, precipitation or extraction.

In DE 101 49 348, the catalyst is separated off from the telomerization mixture by distillation, extraction, precipitation or adsorption and is, if desired, recirculated in its entirety or in part to the telomerization reaction.

DE 103 29 042 refers to the abovementioned patents in respect of the telomerization.

DE 103 08 111 describes, in general terms, the separation of dissolved or colloidal solids, in particular catalysts, from solutions in nonaqueous solvents by means of a membrane.

A disadvantage of the processes known from the prior art is the frequently occurring loss of catalyst, in particular of the catalyst metal, in the separation of the catalyst system from the reaction mixture. In the thermal separation of the catalyst system, decomposition of the metal complex catalyst frequently occurs and the metal of the complex catalyst deposits on the walls of the apparatuses used. Recovery of the metal is often possible only with an increased outlay. Particularly when the catalyst metal is an expensive noble metal, the economics of telomerization processes suffers with the loss of expensive catalyst metal in the separation of the catalyst. Likewise, it is frequently observed that the activity of the catalyst system which has been separated off decreases as a result of the separation process, e.g. by thermal separation, precipitation or extraction, so that large amounts of fresh catalyst have to be added to the recirculated catalyst system or further work-up steps are necessary to achieve the desired activity. In addition, some of the processes proposed in the prior art, in particular the extraction process, are very complicated.

Starting out from this prior art, it was an object of the present invention to provide a process which does not have one or more of the disadvantages of the processes of the prior art. In particular, it was an object of the present invention to provide a simple separation process in which the metal complex catalyst can preferably be separated off very completely and with a very small loss of activity.

A further disadvantage of the processes known from the prior art is that most of the known solvent-stable membranes are not alkali-stable or alkali-stable membranes do not have a sufficient solvent stability. Furthermore, a membrane which under the reaction conditions is stable not only toward the solvent system but also toward the strongly alkaline reaction conditions should be provided.

It has surprisingly been found that a metal complex catalyst can be separated in a simple manner from a telomerization mixture when the separation of the metal complex catalyst is carried out at a membrane under conditions close to those of the reaction and, in particular, a membrane which is stable toward alkali metal compounds and toward solvents is used. In addition, this has the result that the activity of the metal complex catalyst can be largely maintained and the metal complex catalyst can be separated off to a very large extent.

The invention accordingly provides a process for separating a metal complex catalyst from a reaction mixture obtained from a telomerization, wherein the metal complex catalyst is separated off at least one membrane which is preferably stable toward basic alkali metal compounds and toward solvents.

The process of the invention has the advantage that the activity of the catalyst which has been separated off is largely retained. This is possibly due to thermal stressing of the catalyst system, as is frequently observed in thermal separation processes, being avoided. In addition, the process is simple and avoids the use of extraneous materials which would be necessary in extraction or adsorption processes and incur the risk of contamination of the product when the catalyst which has been separated off is returned to the telomerization.

The process of the invention is described by way of example below, without the invention, whose scope is defined by the claims and the description, being restricted thereto. The claims themselves are also part of the disclosure of the present invention. If ranges, general formulae or classes of compounds are indicated below, these are intended to include not only the corresponding ranges or groups of compounds which are explicitly mentioned but also all subranges and subgroups of compounds which can be obtained by leaving out individual values (ranges) or compounds.

In the process of the invention for separating a metal complex catalyst from a reaction mixture obtained from a telomerization, the metal complex catalyst is separated off at least one membrane. If free ligands, in particular free carbene or organophosphorus ligands, are present in addition to the metal complex catalyst in the reaction mixture from the telomerization which is to be treated according to the invention, it can be advantageous for these free ligands also to be separated off at the at least one membrane. To enable the metal complex catalyst and any free ligands present to be separated off, preference is given to using a membrane which is more permeable to the telomerization product than to the metal complex catalyst and preferably also more permeable than to any free ligands present. The suitability of membranes can be determined in a simple manner by means of preliminary tests in which test solutions of complex catalysts and/or free ligands and telomerization product are passed over the membrane to be tested and the permeate and retentate obtained are subsequently analyzed.

In the process of the invention, particular preference is given to using membranes which, owing to their chemical or physical properties, are suitable for retaining the metal complex catalyst and/or free ligand (in particular carbene and/or organophosphorus ligand) to an extent of at least 60% compared to the telomerization product.

A further prerequisite for the usability of the membrane is that the membrane should be stable toward all compounds present in the telomerization reaction mixture, in particular toward any solvents and basic compounds present, in particular compounds of the alkali metals. For this reason, preference is given to using membranes which comprise, as separation-active layer, an alkali- and solvent-stable nanofiltration polymer layer of a material selected from among polyimides (PI), aromatic polyamides (PA), polyamidimides (PAI), polybeizimidazoles, acrylonitrile/glycidyl methacrylate (PANGMA), polybenzimidazolones, polyacrylonitrile (PAN), polyaryl ether sulfones, polyesters, polyether ether ketones (PEEK), polycarbonates (PC), polytetrafluoroethylene, polyvinylidene fluoride (PVDF), polypropylene (PP), polydimethylsiloxane (PDMS) and others as are described, for example, in EP 0 781 166 or DE 103 08 111 and in “Membranes” by I. Cabasso, Encyclopedia of Polymer Science and Technology, John Wiley and Sons, New York, 1987, or consist of one of these materials. Particular preference is given to using membranes which comprise PDMS or polyamidimide or consist of these materials. Membranes whose separation-active layer is composed of polymers having intrinsic microporosity (PIM) or whose separation-active layer is built up over a hydrophobicized ceramic membrane can also be used as membranes in the process of the invention. Such ceramic membranes hydrophobicized with silanes are described, for example, in DE 103 08 111.

The exclusion limit (molecular weight cutoff, MWCO) of preferred membranes is less than 1000 g/mol, preferably less than 600 g/mol, particularly preferably less than 400 g/mol. Such membranes can be procured, for example, from HITK, Hermsdorf or GMT, Rheinfelden. The MWCO indicates the molar mass in g/mol up to which molecules can pass through the membrane.

Apart from the abovementioned materials, the membranes can comprise further materials. In particular, the membranes can comprise support or carrier materials to which the separation-active layer has been applied. In such composite membranes, a support material is present in addition to the actual membrane. A selection of support materials are described in EP 0 781 166, which is explicitly incorporated by reference. Furthermore, reinforcing materials such as particles of inorganic oxides or inorganic fibers such as ceramic or glass fibers which increase the stability of the membranes, in particular to pressure fluctuations or high pressure differences, can be present in the membrane which can be used according to the invention.

The process of the invention is particularly preferably carried out using membranes for which the solubility parameter of the telomerization product, when using an alcohol as telogen especially the ether obtained in the telomerization, differs from the solubility parameter (J. M. Prausnitz, Molecular Thermodynamics of Fluid-Phase Equilibria, Prentice-Hall, N.J., 1969, p298) of the membrane preferably by at least ±50√(kJ/m³), but preferably by not more than 500 √(kJ/m³), preferably by not more than ±400 √(kJ/m³).

The molar volume ratio of the ligands, in particular the carbene or organophosphorus ligands, (free or bound in the complex) to the main product of the telomerization, when using alcohol as telogen especially the ether, should preferably be greater than or equal to 1.5, preferably greater than or equal to 3.0 and particularly preferably greater than or equal to 3.5. As a result of the large molar volume difference, a particularly good separation of ligand and hydroformylation product is achieved at the membrane. The solubility parameters and molecular volumes can be determined as described in EP 0 781 166 B1, in particular in section [0053] and the subsequent sections, and also in the references cited there.

In the process of the invention, the membranes are preferably used in the form of membrane modules. In these modules, the membranes are arranged so that liquid flows over the retentate side of the membranes in such a way that the concentration polarization of the components separated off (the enrichment of the components separated off at the membrane), here catalyst-ligand system, can be countered and, in addition, the necessary driving force (pressure) can be applied. The permeate is collected in the permeate collection space on the permeate side of the membranes and discharged from the module. Customary membrane modules for polymer membranes have the membranes in the form of membrane disks, membrane cushions or membrane pockets. Customary membrane modules for membranes based on ceramic supports have these in the form of tubular modules. In the process of the invention, the membranes are preferably used in the form of membrane modules which have membrane modules having open-channel cushion module systems in which the membranes are thermally welded or adhesively bonded to form membrane pockets or cushions or open-channel (wide-spacer) rolled modules in which the membranes are adhesively bonded or welded to form membrane pockets or membrane cushions and rolled up together with spacers to form a permeate collection tube or have the membrane modules in tubular modules. Membrane modules which have open-channel inflow systems in which the membranes are thermally welded or adhesively bonded to form membrane pockets or membrane cushions can be procured from, for example, Solsep, Apeldoorn (NL) and MET, London (UK) under the names SR-5 or Starmem 240, which can be produced, for example, from the polyimide having the trade name P84 from Degussa A G, Dusseldorf. Membrane modules which have the tubular membranes on a ceramic support can be procured from, for example, Inocermic, Schmalkalden.

To avoid deposits on the membrane, the process is preferably carried out so that the membrane separation steps, in particular the first membrane separation step, is/are carried out at a flow velocity at the membrane of from 0.1 to 15 m/sec, preferably from 0.2 to 4 m/sec, more preferably from 0.3 to 1 m/sec.

The process of the invention can be carried out using one, two or more membrane(s) or using one, two or more membrane module(s). Depending on the separation power of the membrane and the desired retention, the desired retention can be achieved by connecting a plurality of membranes or membrane modules in series. The arrangement in series can be effected so that either the retentate or the permeate, preferably the permeate, of a first membrane separation is passed as feed to a further membrane separation. Any further membrane separation(s) following the first membrane separation according to the invention can be carried out under the same conditions as the first membrane separation or under different conditions, in particular different temperatures or pressures.

The process of the invention is preferably operated so that the telomerization mixture is supplied as feed to the membrane and the retentate stream is partly recirculated to the membrane. The substream which is recirculated to the membrane is in this case combined with the feed. The part of the retentate stream which is not recirculated to the membrane is either used as feed for one or more subsequent separation stages or else is recirculated to the reaction.

The volume flow ratio of permeate stream to feed stream (without recirculated retentate) is preferably from 1:5 to 1:20, more preferably from 1:7.5 to 1:12.5 and particularly preferably from 1:9 to 1:11. The volume flow ratio can be adjusted by altering the differential pressure in combination with a regulation of the amount of retentate based on the permeate volume flow produced.

It can be advantageous for the volume flow passed over the membrane to be significantly greater than the volume flow of the permeate stream, since a high flow velocity over the membrane can be set in this simple way. The volume flow ratio of the stream fed to the membrane (feed including recirculated retentate) to permeate stream is preferably 100-10 000:1, more preferably 500-5000:1 and particularly preferably 750-1250:1. A relatively high volume flow is thus preferably circulated over the membrane. The size of the part of the retentate stream which is recirculated to the reaction or passed to a further separation is given by the difference between feed stream (without recirculated retentate) and permeate stream.

The separation process of the invention can be carried out as a pressure-driven process. The membrane separation is preferably carried out so that there is a pressure difference from the retentate side to the permeate side of at least 0.5 MPa, preferably from 0.5 to 10 MPa, more preferably from 1 to 5 MPa. If the pressure is significantly below the minimum pressure difference, the transmembrane flux becomes too low. If the pressure difference significantly exceeds a value of 10 MPa, most membranes begin to compact, which likewise leads to a reduction in the transmembrane flux.

The permeate obtained at the membrane preferably has a composition in which the proportion of metal complex catalyst and/or free organophosphorus ligand is at least 50%, preferably at least 70%, particularly preferably at least 80% and very particularly preferably more than 90%, smaller than that in the retentate.

The permeate which is obtained from the process of the present invention can be worked up in a conventional way. Thus, the permeate can be passed to a thermal separation stage, e.g. realized by means of one or more thermal separation apparatuses such as thin film evaporators, falling film evaporators, flash evaporators or distillation columns. The overhead product obtained comprises the telomerization product and any unreacted hydrocarbons, e.g. dienes, olefins or aliphatics, possibly unreacted telogen and any solvent which is used in the telomerization and has a boiling point in the region of that of the telomerization products or below and can be passed to a further work-up. The bottom product obtained from this first separation apparatus is a mixture comprising the complex catalyst and/or free ligands, any solvent having a boiling point higher than that of the telomerization product and also high boilers formed during the telomerization. This bottom product is, preferably after discharge of part of the high boilers, which can be effected thermally or by means of a (membrane) filtration, recirculated to the telomerization.

The permeate which is obtained from the process of the present invention can, however, also be passed to an extraction, precipitation or adsorption as described in the prior art.

To keep the losses of catalyst, in particular of active metal complex catalyst, as low as possible, the process is preferably carried out so that at least 80%, preferably at least 90% and particularly preferably at least 95%, of the metal complex catalyst originally present in the telomerization mixture is separated off from the telomerization mixture by means of the membrane separation at one or more membranes and the remainder of the complex catalyst is separated off in subsequent separation stages.

It can be advantageous for part of the constituents to be removed from the permeate before it is fed to the thermal separation stage. In particular, it can be advantageous for constituents which are gaseous under the pressure conditions under which the thermal separation stage is operated to be separated off from the permeate. Such constituents can be, for example, unreacted hydrocarbons or unreacted telogens. To separate off these constituents, the permeate is preferably fed to a degassing stage in which the permeate is depressurized to a lower pressure, preferably a pressure which is equal to or not more than 10% above the pressure in the thermal separation stage. The substances which are gaseous after the depressurization are separated off and can be worked up or disposed of or else be recirculated directly to the reaction. The remaining constituents of the permeate which remain liquid are then passed to the thermal separation stage.

As a result of the coupled separation of complex catalyst and/or free ligand from the reaction mixture in the membrane separation and subsequent conventional separation, the complex catalyst can be separated essentially completely from the telomerization mixture under relatively mild conditions and can therefore mostly be returned to the process in the active form. Any inactive catalyst formed in the thermal separation can be discharged together with the high boilers and, for example, be recovered by work-up to the pure elemental metal. The metal complex catalyst separated off in the membrane separation and, if appropriate, in the subsequent conventional separation can be recirculated to the telomerization. Likewise, any free ligand present in the reaction mixture, preferably selected from among organophosphorus or carbene ligand, can be removed at the membrane and, if appropriate, in a subsequent conventional separation and recirculated to the telomerization.

In a particularly preferred embodiment of the process of the invention, the telomerization mixture is fed to the membrane under conditions which in terms of pressure and temperature (in ° C.) differ by not more than from 0 to 50%, preferably from 0 to 30% and more preferably from 0 to 10% from the reaction conditions of the telomerization. The telomerization mixture is particularly preferably fed to the membrane under conditions which in terms of pressure and temperature differ by no more than 0 to 50%, preferably no more than 0 to 30%, more preferably by no more than 0 to 10% and particularly preferably not at all, from the reaction conditions of the telomerization.

As telomerization mixtures, it is possible to use all known telomerization mixtures as are obtained, for example, in the abovementioned prior art in the process of the invention.

As reaction mixture from a telomerization, preference is given to using a telomerization mixture which is obtained by telomerization of acyclic olefins having at least two conjugated double bonds with at least one nucleophile (telogen) using a catalyst comprising a metal of group 8, 9 or 10 of the Periodic Table of the Elements.

In a preferred telomerization, the pure acyclic olefins having conjugated double bonds, mixtures of various olefins of this type or mixtures of one or more of the olefins mentioned with other hydrocarbons can be used as starting materials. Preference is given to using a mixture of hydrocarbons comprising acyclic olefins, preferably an acyclic olefin having at least two conjugated double bonds, in admixture with other hydrocarbons as starting material.

Particular preference is given to using 1,3-butadiene and/or isoprene, in each case either as pure substance, a mixture of the pure substances or a mixture of one or both olefins with other hydrocarbons, as acyclic olefins having conjugated double bonds in the telomerization. The telomerization is very particularly preferably carried out using a mixture of which over 90% by weight is made up of C₄-hydrocarbons and which comprises 1,3-butadiene as acyclic olefin as starting material.

1,3-Butadiene-rich hydrocarbon streams are particularly preferred as starting materials for the telomerization. The hydrocarbon stream used can, in particular, be a C₄-hydrocarbon fraction. The hydrocarbon streams can preferably be, for example, mixtures of 1,3-butadiene with other C₄- and C₃- or C₅-hydrocarbons. Such mixtures are obtained, for example, in cracking processes for the production of ethylene and propylene in which refinery gases, naphtha, gas oil, LPG (liquefied petroleum gas), NGL (natural gas liquid), etc., are reacted. The C₄ fractions obtained as by-product in the processes can comprise 1,3-butadiene together with monoolefins (1-butene, cis-2-butene, trans-2-butene, isobutene), saturated hydrocarbons (n-butane, isobutane), acetylenically unsaturated compounds (ethylacetylene (butyne), vinylacetylene (butenyne), methylacetylene (propyne)) and allenically unsaturated compounds (mainly 1,2-butadiene). Furthermore, these fractions can contain small amounts of C₃- and C₅-hydrocarbons. The composition of the C₄ fractions is dependent on the particular cracking process, the operating parameters and the feedstock. The concentrations of the individual components are typically in the following ranges:

| Component | % by mass |
|---|---|
| 1,3-butadiene | 25-70 |
| 1-butene | 9-25 |
| 2-butenes | 4-20 |
| Isobutene | 10-35 |
| n-butane | 0.5-8 |
| Isobutane | 0.5-6 |
| Σ acetylenic compounds | 0.05-4 |
| 1,2-butadiene | 0.05-2 |

In the preferred telomerization whose reaction mixture is used in the process of the invention, hydrocarbon mixtures having a 1,3-butadiene content of greater than 35% by mass are preferably used.

The hydrocarbons used as starting material can frequently contain traces of oxygen compounds, nitrogen compounds, sulfur compounds, halogen compounds, in particular chlorine compounds, and heavy metal compounds which could interfere in the process of the invention. It is therefore advantageous to separate off these substances first. Interfering compounds can be, for example, carbon dioxide or carbonyl compounds, e.g. acetone or acetaldehyde. The removal of these impurities can be carried out, for example, by scrubbing, in particular with water or aqueous solutions, or by adsorption. A water scrub enables hydrophilic components such as nitrogen components to be entirely or partly removed from the hydrocarbon mixture. Examples of nitrogen components are acetonitrile or N-methylpyrrolidone (NMP). Oxygen compounds can also be partly removed by means of a water scrub. The water scrub can be carried out directly using water or else using aqueous solutions which may comprise, for example, salts such as NaHSO₃ (U.S. Pat. No. 3,682,779, U.S. Pat. No. 3,308,201, U.S. Pat. No. 4,125,568, U.S. Pat. No. 3,336,414 or U.S. Pat. No. 5,122,236).

It can be advantageous for the hydrocarbon mixture to go through a drying step after the water scrub. Drying can be carried out by the methods known in the prior art. If dissolved water is present, drying can be carried out, for example, using molecular sieves as desiccant or by azeotropic distillation. Free water can be separated off by phase separation, e.g. using a coalescer.

Adsorbers can be used to remove impurities present in the trace range. This can be advantageous when, in particular, noble metal catalysts which suffer a significant decrease in activity in the presence of only traces of impurities are used in the telomerization step. Nitrogen compounds or sulfur compounds are often removed by means of upstream adsorbers. Examples of adsorbents are aluminum oxides, molecular sieves, zeolites, activated carbon or aluminas impregnated with metals (e.g. U.S. Pat. No. 4,571,445 or WO 02/53685). Adsorbents are marketed by various companies, for example by Alcoa under the name Selexsorb®, by UOP or by Axens, e.g. with the product series SAS, MS, AA, TG, TGS or CMG.

Any interfering acetylenically unsaturated compounds can be separated off from the hydrocarbon mixture used in the telomerization by, for example, extraction. Such an extraction has been known for a long time and is, as work-up step, an integral part of most plants which isolate 1,3-butadiene from cracking C₄. One process for the extractive removal of acetylenically unsaturated compounds from cracking C₄ is described, for example, in Erdöl und Kohle-Erdgas-Petiochemie vereinigt mit Brennstoffchemie vol. 34, number 8, August 1981, pages 343-346. In this process, the multiply unsaturated hydrocarbons and also the acetylenically unsaturated compounds are separated from the monoolefins and saturated hydrocarbons by extractive distillation in a first stage. The unsaturated hydrocarbons are separated off from the NMP extract by distillation and the acetylenically unsaturated compounds having 4 carbon atoms are separated from the hydrocarbon distillate by means of a second extractive distillation with water-containing NMP. In the work-up of cracking C₄, pure 1,3-butadiene is separated by means of two further distillations, with methylacetylene and 1,2-butadiene being obtained as by-products.

The separation of acetylenic compounds from a 1,3-butadiene-containing stream can optionally be carried out using one or more ionic liquid(s), e.g. as extractant.

The hydrocarbon streams obtained by extraction, which preferably contain less than 5% by weight of acetylenic compounds, can particularly preferably be used directly as starting material in the telomerization.

The partial removal of the acetylenically unsaturated compounds from the hydrocarbon stream to be used can, however, also be carried out by selective hydrogenation of the acetylenically unsaturated compounds in the presence of dienes and monoolefins, e.g. over copper-containing, palladium-containing or mixed catalysts.

As acetylenically unsaturated compounds, the starting materials used in the telomerization, especially when using 1,3-butadiene-containing C₄-hydrocarbon mixtures, frequently contain, in particular, vinylacetylene and 1-butyne.

The telomerization mixture used in the process of the invention preferably originates from a telomerization in which metal complex catalysts, in particular metal-carbene complexes, of the metals palladium (Pd), iron (Fe), ruthenium (Ru), osmium (Os), cobalt (Co), rhodium (Rh), iridium (Ir), nickel (Ni) or platinum (Pt) are used as catalyst system. As ligands, it is possible to use, for example, phosphorus ligands such as phosphines, phosphinines, phosphinites or phosphites, e.g. triphenylphosphine, and/or carbene ligands. It can also be advantageous to use different ligands simultaneously.

Preference is given to using palladium compounds, in particular palladium-carbene complexes, as catalysts in the telomerization step. The ligands in the metal complex catalysts used as catalyst are particularly preferably trivalent phosphorus compounds or carbenes.

Metal complex catalysts having at least one carbene stabilized by heteroatoms as ligand are particularly preferably used as catalyst in the telomerization. Examples of such ligands are described, inter alia, in the documents DE 101 28 144, DE 101 49 348, DE 101 48 722, DE 100 62 577, EP 1 308 157 and WO 01/66248. These documents and in particular the ligands described there are incorporated by reference into the disclosure of the present patent application. In addition, the active complex can have further ligands. The carbene ligands can be open ligands or cyclic ligands.

As telomerization catalyst in the telomerization, preference is given to using a palladium-carbene complex comprising a carbene ligand of the general formula (VIII)

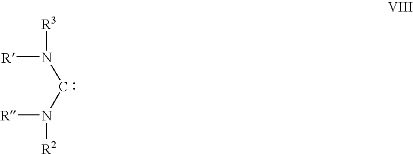

where R², R″, R′ and R³ are identical or different and are each hydrogen or hydrocarbon groups, the hydrocarbon groups being identical or different linear, branched or cyclic radicals selected from the group consisting of alkyl radicals having from 1 to 50 carbon atoms, alkenyl radicals having from 2 to 50 carbon atoms, alkynyl radicals having from 2 to 50 carbon atoms and aryl radicals having from 6 to 30 carbon atoms in which at least one hydrogen atom may be replaced by a functional group,
and/or R² and R″ and/or R′ and R³ are part of a cyclic system which may be identical or different and has a carbon skeleton of the formula VIII having from 2 to 20 carbon atoms and a nitrogen atom, the carbon atoms of R² and R″ and/or R′ and R³ not being counted and at least one hydrogen atom in the cyclic system being able to be replaced by a functional group and/or at least one carbon atom of the cyclic system being able to be replaced by a heteroatom selected from the group consisting of S, P, O and N,
and/or R² and/or R″ and/or R′ and/or R³ are connected by a bridge having from 1 to 20 carbon atoms to a ligand L, the carbon atoms of the radicals R², R″, R′ and R³ not being counted,
and L is a further ligand which is an uncharged two-electron donor, part of a cyclic system and/or an anionic ligand, the functional groups being able to be selected, for example, from among the groups: —CN, —COOH, —COO-alkyl-, —COO-aryl-, —OCO-alkyl-, —OCO-aryl-, —OCOO-alkyl-, —OCOO-aryl-, —CHO, —CO-alkyl-, —CO-aryl-, —O-alkyl-, —O-aryl-, —NH₂, —NH(alkyl)-, —N(alkyl)₂-, —NH(aryl)-, —N(alkyl)₂-, —F, —Cl, —Br, —I, —OH, —CF₃, —NO₂, -ferrocenyl, —SO₃H and —PO₃H₂, the alkyl groups being able to have, for example, 1-24 carbon atoms and the aryl groups being able to have, for example, from 5 to 24 carbon atoms. The preparation of such ligands may be found, for example, in DE 101 48 722. In the telomerization whose reaction mixture is fed to the membrane in the process of the invention, preference is given to using a palladium-carbene complex comprising a carbene ligand of the general formula (VIII) in which
R²; R³: identical or different linear, branched, substituted or unsubstituted cyclic or alicyclic alkyl groups having from 1 to 24 carbon atoms or
   substituted or unsubstituted, monocyclic or polycyclic aryl groups having from 6 to 24 carbon atoms or
   monocyclic or polycyclic, substituted or unsubstituted heterocycle having from 4 to 24 carbon atoms and at least one heteroatom from the group consisting of N, O, S,
R′, R″: identical or different
   hydrogen, alkyl, aryl, heteroaryl, —CN, —COOH, —COO-alkyl-, —COO-aryl-, —OCO-alkyl-, —OCO-aryl-, —OCOO-alkyl-, —OCOO-aryl-, —CHO, —CO-alkyl-, —CO-aryl-, —O-alkyl-, —O-aryl-, —NH₂, —NH(alkyl)-, —N(alkyl)₂-, —NH(aryl)-, —N(alkyl)₂-, —F, —Cl, —Br, —I, —OH, —CF₃, —NO₂, -ferrocenyl, —SO₃H, —PO₃H₂, the alkyl groups having 1-24 carbon atoms and the aryl and heteroaryl groups having from 5 to 24 carbon atoms and the radicals R′ and R″ also being able to be part of a bridging aliphatic or aromatic ring,
      as telomerization catalyst.

Very particular preference is given to using carbene ligands which have a 5-membered ring. Ligands having a 5-membered ring which are preferably used in the process of the invention are, for example, ligands of the formulae IX, X, XI and XII

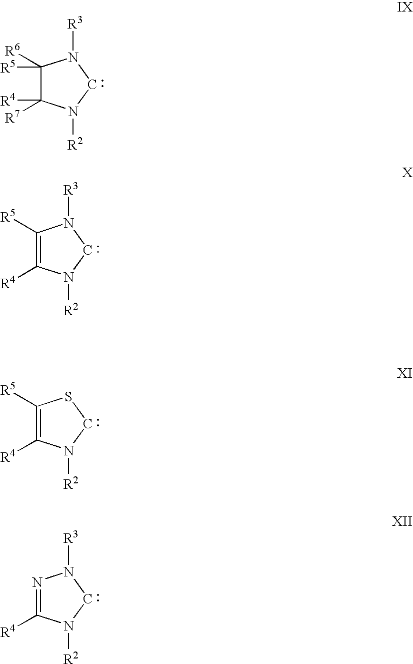

where R²; R³: identical or different
linear, branched, substituted or unsubstituted cyclic or alicyclic alkyl groups having from 1 to 24 carbon atoms or
substituted or unsubstituted, monocyclic or polycyclic aryl groups having from 6 to 24 carbon atoms or
monocyclic or polycyclic, substituted or unsubstituted heterocycle having from 4 to 24 carbon atoms and at least one heteroatom from the group consisting of N, O, S,
   R⁴, R⁵, R⁶, R⁷: identical or different
hydrogen, alkyl, aryl, heteroaryl, —CN, —COOH, —COO-alkyl-, —COO-aryl, —OCO-alkyl-, —OCO-aryl-, —OCOO-alkyl-, —OCOO-aryl-, —CHO, —CO-alkyl-, —CO-aryl-, —O-alkyl-, —O-aryl-, —NH₂, —NH(alkyl)-, —N(alkyl)₂-, —NH(aryl)-, —N(alkyl)₂-, —F, —Cl, —Br, —I, —OH, —CF₃, —NO₂, -ferrocenyl, —SO₃H, —PO₃H₂, the alkyl groups having 1-24 carbon atoms and the aryl and heteroaryl groups having from 5 to 24 carbon atoms and the radicals R′ and R″ also able to be part of a bridging aliphatic or aromatic ring.

Examples of carbene ligands which correspond to the general formulae IX and X and complexes containing such ligands have been described in the technical literature (W. A. Herrmann, C. Köcher, Angew. Chem. 1997, 109, 2257; Angew. Chem. Int. Ed. Engl. 1997, 36, 2162; V. P. W. Böhm, C. W. K. Gstöttmayr, T. Weskamp, W. A. Herrmann, J. Organomet. Chem. 2000, 595, 186; DE 44 47 066).

The radicals R² and R³ can be, in particular, a monocyclic or polycyclic ring which contains at least one heteroatom selected from among the elements nitrogen, oxygen and sulfur and may, if desired, have further substituents selected from among the groups —CN, —COOH, —COO-alkyl-, —COO-aryl-, —OCO-alkyl-, —OCO-aryl-, —OCOO-alkyl-, —OCOO-aryl-, —CHO, —CO-alkyl-, —CO-aryl-, -aryl-, -alkyl-, —O-alkyl-, —O-aryl-, —NH₂, —NH(alkyl)-, —N(alkyl)₂-, —NH(aryl)- —N(alkyl)₂-, —F, —Cl, —Br, —I, —OH, —CF₃, —NO₂, -ferrocenyl, —SO₃H, —PO₃H₂. The alkyl groups have from 1 to 24 carbon atoms and the aryl groups have from 5 to 24 carbon atoms. If Pd is used as metal of groups 8 to 10 of the Periodic Table, one or both of the ligands R² and R³ preferably has these meanings.

The radicals R², R³, R⁴, R⁵, R⁶ and/or R⁷ can be identical or different and may have at least one substituent from the group consisting of —H, —CN, —COOH, —COO-alkyl, —COO-aryl, —OCO-alkyl, —OCO-aryl, —OCOO-alkyl, —OCOO-aryl, —CHO, —CO-alkyl, —CO-aryl, -aryl, -alkyl, -alkenyl, -allyl, —O-alkyl, —O-aryl, —NH₂, —NH(alkyl), —N(alkyl)₂, —NH(aryl), —N(alkyl)₂, —F, —Cl, —Br, —I, —OH, —CF₃, —NO₂, -ferrocenyl, —SO₃H, —PO₃H₂, the alkyl groups having from 1 to 24 carbon atoms, preferably from 1 to 20 carbon atoms, the alkenyl groups having from 2 to 24 carbon atoms, the allyl groups having from 3 to 24 carbon atoms and the monocyclic or polycyclic aryl groups having from 5 to 24 carbon atoms. The radicals R₄ to R₆ can, for example, be covalently linked to one another via CH₂— or CH groups.

The substituents having acidic hydrogen atoms can also have metal or ammonium ions in place of the protons.

The radicals R² and R³ can particularly preferably be radicals derived from five- and six-membered heteroalkanes, heteroalkenes and heteroaromatics, e.g. 1,4-dioxane, morpholine, γ-pyran, pyridine, pyrimidine, pyrazine, pyrrole, furan, thiophene, pyrazole, imidazole, thiazole and oxazole. The following table shows specific examples of such radicals R² and R³. In these, ˜ in each case denotes the point of linkage to the five-membered heterocycle.

| | | | |
|---|---|---|---|
| 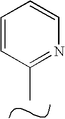 A-1 | 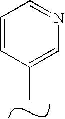 A-2 | 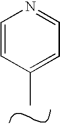 A-3 | 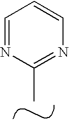 A-19 |
| 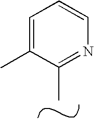 A-4 | 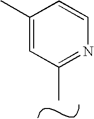 A-5 | 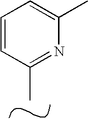 A-6 | 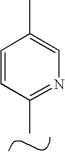 A-7 |
| 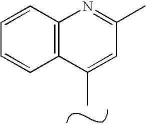 A-8 | 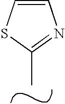 A-9 | 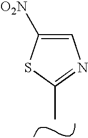 A-10 | 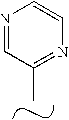 A-11 |
| 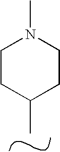 A-12 | 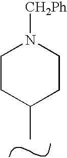 A-13 | 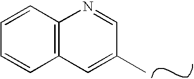 A-14 | 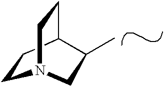 A-15 |
| 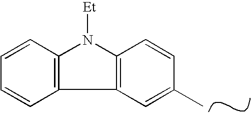 A-16 | 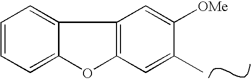 A-17 | 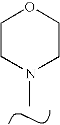 A-18 | |

For the purposes of the present invention, carbene ligands include both free carbenes which can function as ligand and carbenes coordinated to a metal.

The catalyst metal, in particular the palladium used as catalyst metal, from which the active catalysts are formed under the reaction conditions can be introduced into the telomerization process in various ways.

The metal (palladium) can be introduced into the telomerization process
a) as metal-carbene complex (palladium-carbene complex), the metal (palladium) preferably being in the oxidation state (II) or (0) or
b) in the form of metal compounds (palladium compounds as precursors) from which the catalysts are formed in situ.

### Regarding a)

Examples are palladium(0)-carbene-olefin complexes, palladium(0)-dicarbene complexes and palladium(II)-dicarbene complexes, palladium(0)-carbene-1,6-diene complexes. 1,6-Diene can be, for example, diallylamine, 1,1′-divinyltetramethyldisiloxane, 2,7-octadienyl ethers or 2,7-octadienylamines. Examples are shown in the formulae I-a to I-e below.

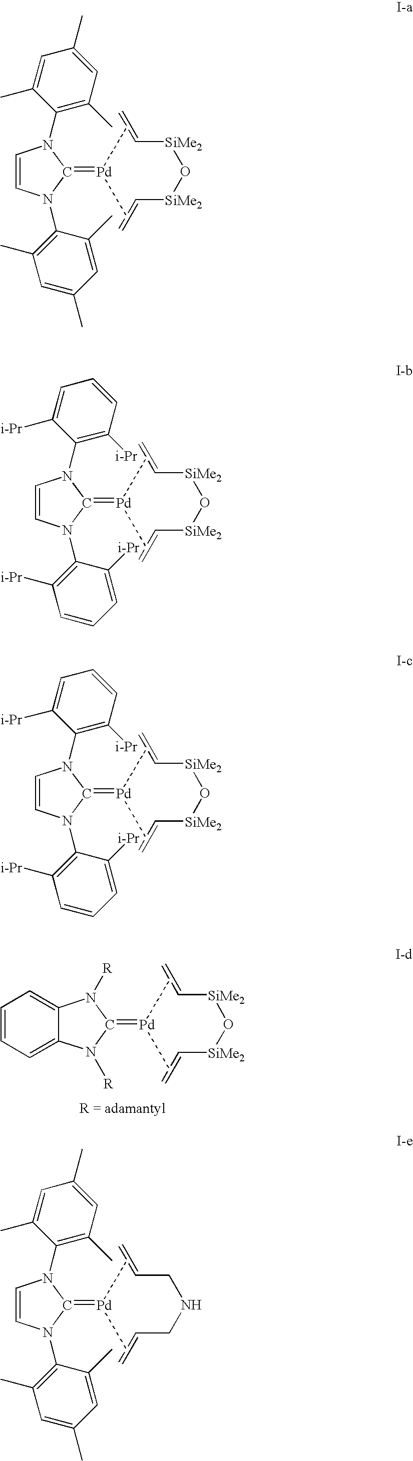

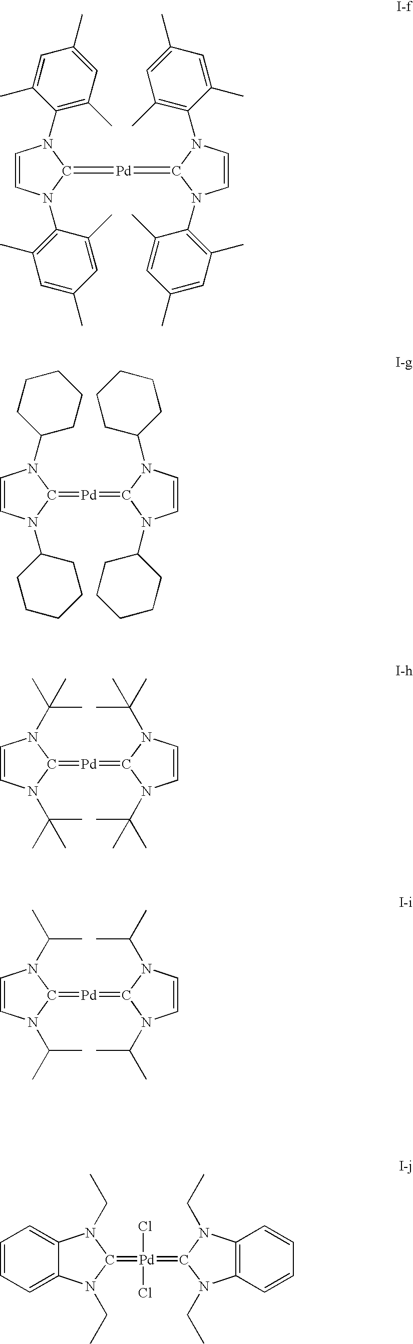

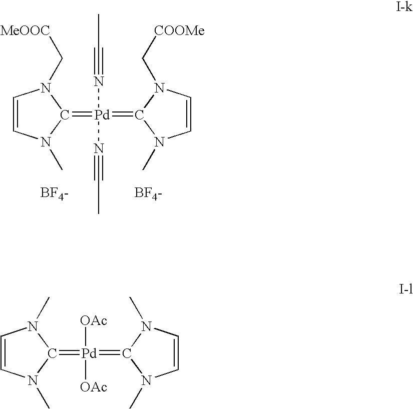

The carbene complexes of palladium can be prepared in a wide variety of ways. A simple route is, for example, the addition of carbene ligands or the replacement of ligands on palladium complexes by carbene ligands. Thus, for example, the complexes I-f to I-i can be obtained by replacement of the phosphorus ligands of the complex bis(tri-o-tolylphosphine)palladium(0) (T. Weskamp, W. A. Herrmann, J. Organomet. Chem. 2000, 595, 186).

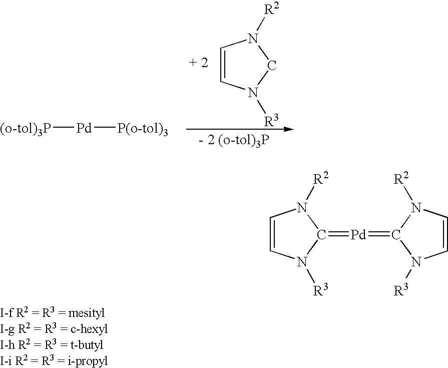

### Regarding b)

As palladium precursors, it is possible to use, for example: palladium(II) acetate, palladium(II) chloride, palladium(II) bromide, lithium tetrachloropalladate, palladium(II) acetylacetonate, dibenzylideneacetonepalladium(0) complexes, palladium(II) propionate, bisacetonitrilepalladium(II) chloride, bistriphenylphosphanepalladium(II)-dichloride, bisbenzonitrilepalladium(II) chloride, bis(tri-o-tolylphosphine)palladium(0) and further palladium(0) and palladium(II) complexes.

The carbenes of the general formulae IX and X can be used in the form of free carbenes or as metal complexes or be generated in situ from carbene precursors.

Suitable carbene precursors are, for example, carbene salts of the general formulae XIII and XIV,

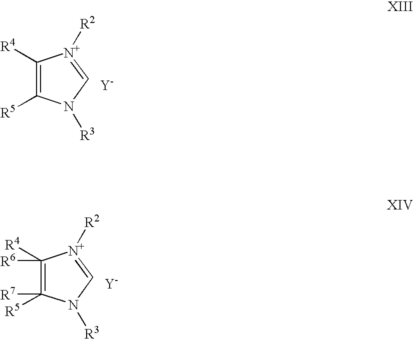

where R², R³, R⁴, R⁵, R⁶, R⁷ have the same meanings as in the formulae IX and X and Y is a singly charged anionic group or, corresponding to the stoichiometry, part of a multiply charged anionic group.

Examples of Y are halides, hydrogensulfates, sulfate, alkylsulfonates, arylsulfonates, borates, hydrogencarbonate, carbonate, alkylcarboxylates, arylcarboxylates and phenoxides.

The corresponding carbenes can be set free from the salts of the carbenes by, for example, reaction with a base.

The concentration of the metal complex catalyst, reported formally in ppm (mass) of palladium metal based on the total mass, in the telomerization mixture is preferably from 0.01 ppm to 1000 ppm, preferably from 0.5 to 100 ppm, particularly preferably from 1 to 50 ppm. The ratio [mol/mol] of carbene or organophosphorus ligand, preferably carbene ligand, to metal, in particular Pd, is preferably from 0.01:1 to 250:1, particularly preferably from 1:1 to 100:1 and very particularly preferably from 1:1 to 50:1. Apart from the carbene ligands, further ligands, for example the abovementioned organophosphorus ligands such as triphenylphosphine, can also be present in the telomerization mixture.

As nucleophile (VII) in the telomerization, preference is given to using compounds of the general formula

R^{1a}—O—H (VIIa)

or (R^{1a})(R^{1b})N—H (VIIb)

or R^{1a}—COOH (VIIc)

where R^{1a} and R^{1b} are selected independently from among hydrogen, a linear, branched or cyclic C₁-C₂₂-alkyl group, an alkenyl group, an alkynyl group, a C₅-C₁₈-aryl group or a —CO-alkyl-(C₁-C₈) group or a —CO-aryl-(C₅-C₁₀) group, these groups being able to contain substituents selected from the group consisting of —CN, —COOH, —COO-alkyl-(C₁-C₈), —CO-alkyl-(C₁-C₈), -aryl-(C₅-C₁₀), —COO-aryl-(C₆-C₁₀), —CO-aryl-(C₆-C₁₀), —O-alkyl-(C₁-C₈), —O—CO-alkyl-(C₁-C₈), —N-alkyl₂-(C₁-C₈), —CHO, —SO₃H, —NH₂, —F, —Cl, —OH, —CF₃, —NO₂ and the radicals R^{1a} and R^{1b} being able to be joined to one another via covalent bonds. Preference is given to using compounds in which the radicals R^{1a} and, if appropriate, R^{1b} are each hydrogen, methyl, ethyl, n-propyl, isopropyl, tert-butyl, n-butyl, sec-butyl, pentyl, hexyl, heptyl, octyl, octenyl, octadienyl, isononyl, 2-ethylhexyl, n-nonyl, phenyl, m-, o- or p-methylphenyl, naphthyl, 2,4-di-tert-butylphenyl, 2,6-di-tert-butylmethylphenyl, hydrogencarbonyl, methylcarbonyl, ethylcarbonyl, propylcarbonyl or phenylcarbonyl as nucleophiles.

In the telomerization whose reaction mixture is fed to the membrane in the process of the invention, particular preference is given to using water, alcohols, phenols, polyols, carboxylic acids, ammonia and/or primary or secondary amines as nucleophiles (VII). Specifically, these are:
water, ammonia,
monoalcohols and phenols, for example methanol, ethanol, n-propanol, isopropanol, allyl alcohol, n-butanol, i-butanol, octanol, 2-ethylhexanol, isononanol, benzyl alcohol, cyclohexanol, cyclopentanol or 2,7-octadien-1-ol, phenol,
dialcohols such as ethylene glycol, 1,2-propanediol, 1,3-propanediol, 1,4-butanediol, 1,2-butanediol, 2,3-butanediol and 1,3-butanediol,
hydroxy compounds such as α-hydroxyacetic esters,
primary amines such as methylamine, ethylamine, propylamine, butylamine, octylamine, 2,7-octadienylamine, dodecylamine, ethylenediamine or hexamethylenediamine,
secondary amines such as dimethylamine, diethylamine, N-methylaniline, bis(2,7-octadienyl)amine, dicyclohexylamine, methylcyclohexylamine, pyrrolidine, piperidine, morpholine, piperazine or hexamethylenimine or
carboxylic acids such as formic acid, acetic acid, propanoic acid, butenoic acid, isobutenoic acid, benzoic acid, 1,2-benzenedicarboxylic acid (phthalic acid).

Very particular preference is given to using methanol, ethanol, 2-ethylhexanol, octanol, octenol, octadienol, isopropanol, n-propanol, isobutanol, n-butanol, isononanol, formic acid, acetic acid, propionic acid, n-butanoic acid, isobutanoic acid, benzoic acid, phthalic acid, phenol, dimethylamine, methylamine, ammonia and/or water as nucleophiles (VII) in the telomerization. Methanol is advantageously used as nucleophile.

In determining the ratio of nucleophile to the starting olefin having at least two conjugated double bonds which is to be reacted in the telomerization, the number of active hydrogen atoms in the telogen has to be taken into account. Thus, for example, methanol has one active hydrogen atom, ethylene glycol has two, methylamine has two, etc.

Preference is given to using from 0.001 mol to 10 mol of starting olefin per mol of active hydrogen atom of the nucleophile which can react with the starting olefin in the telomerization reaction. When the telomerization reaction is carried out with a liquid phase, a ratio of from 0.1 mol to 2 mol of starting olefin per mol of active hydrogen is particularly preferred.

It can be advantageous for the telomerization to be carried out in the presence of a solvent. As solvent for the telomerization reaction, it is possible to use the nucleophile employed if it is present as a liquid under the reaction conditions and/or inert organic solvents. The addition of solvents is preferred when nucleophiles which are present as solids under the reaction conditions are used or in the case of products which would be obtained as solids under the reaction conditions of the telomerization. Suitable solvents include, inter alia, aliphatic, cycloaliphatic and aromatic hydrocarbons, for example C₃-C₂₀-alkanes, mixtures of lower alkanes (C₃-C₂₀), cyclohexane, cyclooctane, ethylcyclohexane, alkenes and polyenes, vinylcyclohexene, the C₄-hydrocarbons from cracking C₄ fractions, benzene, toluene and xylene; polar solvents such as tertiary and secondary alcohols, amides such as acetamide, dimethylacetamide and dimethylformamide, nitriles such as acetonitrile and benzonitrile, ketones such as acetone, methyl isobutyl ketone and diethyl ketone; carboxylic esters such as ethyl acetate, ethers such as dipropyl ether, diethyl ether, dimethyl ether, methyl octyl ether, methyl tert-butyl ether, ethyl tert-butyl ether, 3-methoxyoctane, dioxane, tetrahydrofuran, anisole, alkyl and aryl ethers of ethylene glycol, diethylene glycol, triethylene glycol, tetraethylene glycol, polyethylene glycol, propylene glycol, dipropylene glycol, tripropylene glycol and polypropylene glycol and other polar solvents such as sulfolane, dimethyl sulfoxide, ethylene carbonate, propylene carbonate and water. Ionic liquids, for example imidazolium or pyridinium salts, can also be used as solvents. The solvents can be used either alone or as mixtures of various solvents.

It is often advantageous to carry out the telomerization reaction in the presence of bases. Preference is given to using basic components having a pK_{b} of less than 7, in particular compounds selected from the group consisting of amines, alkoxides, phenoxides, alkali metal salts and alkaline earth metal salts.

Suitable basic components are, for example, amines such as trialkylamines, which may be alicyclic and/or open-chain, amides, alkali metal or/and alkaline earth metal salts of aliphatic or/and aromatic carboxylic acids, e.g. acetates, propionates, benzoates or corresponding carbonates, hydrogencarbonates, alkoxides of alkali metal and/or alkaline earth metal elements, phosphates, hydrogenphosphates or/and hydroxides preferably of lithium, sodium, potassium, calcium, magnesium, cesium, ammonium and phosphonium compounds. Preferred additives are hydroxides of the alkali metal and alkaline earth metal elements and metal salts of the nucleophile (VII) of the general formulae IV, V or VI,

ROMe IV

R¹R²NMe V

RCOOMe VI

where Me=a monovalent metal or a monovalent metal equivalent, R and R¹ have the meanings as given above for R^{1a} and R² have the meanings as given above for R^{1b}.

The basic component is preferably used in an amount of from 0.01 mol % to 10 mol % (based on the starting olefin), preferably from 0.1 mol % to 5 mol % and very particularly preferably from 0.2 mol % to 1 mol %.

The telomerization can be operated continuously or batchwise and is not restricted to the use of particular types of reactors. Examples of reactors in which the reaction can be carried out are stirred tank reactors, cascades of stirred tanks, flow tubes and loop reactors. Combinations of various reactors are also possible, for example a stirred tank reactor with a downstream flow tube.

The telomerization is, with a view to a high space-time yield, preferably not carried out to complete conversion of the starting olefin. This can be advantageous particularly when the starting olefin is 1,3-butadiene. In this case, it is preferable, particularly when methanol is used as nucleophile, to limit the conversion to not more than 95%, particularly preferably to 88%.

The temperature at which the telomerization reaction is carried out is preferably in the range from 10 to 180° C., more preferably in the range from 30 to 120° C. and particularly preferably in the range from 40 to 100° C. The reaction is preferably carried out at atmospheric pressure or at superatmospheric pressure, in particular at a superatmospheric pressure of from 0.15 to 30 MPa, preferably from 0.2 to 12 MPa, particularly preferably from 0.5 to 6.4 MPa and very particularly preferably from 1 to 5 MPa.

In the preferred embodiment in which the membrane separation is effected under conditions which are in the range of the reaction conditions of the telomerization, the process of the invention is therefore preferably carried out with the membrane separation being carried out at a temperature of preferably from 5 to 180° C., more preferably from 15 to 120° C. and particularly preferably from 20 to 100° C. The membrane separation is very particularly preferably carried out at a temperature of from 80 to 100° C. The membrane separation is for the same reason preferably carried out at atmospheric pressure or at superatmospheric pressure, in particular at a superatmospheric pressure of from 0.075 to 30 MPa, preferably from 0.1 to 12 MPa, particularly preferably from 0.25 to 6.4 MPa and very particularly preferably from 0.5 to 5 MPa.

The process of the invention can be used, in particular, for preparing a compound of the formula II

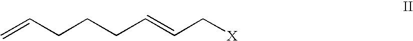

where X is a radical OR^{1a} or NR^{1a}R^{1b}, where R^{1a} and R^{1b} are selected independently from among hydrogen, a linear, branched or cyclic C₁-C₂₂-alkyl group, an alkenyl group, an alkynyl group, a C₅-C₁₈-aryl group and a —CO-alkyl-(C₁-C₈) group and a —CO-aryl-(C₅-C₁₀) group, these groups being able to contain substituents selected from the group consisting of —CN, —COOH, —COO-alkyl-(C₁-C₈), —CO-alkyl-(C₁-C₈), -aryl-(C₅-C₁₀), —COO-aryl-(C₆-C₁₀), —CO-aryl-(C₆-C₁₀), —O-alkyl-(C₁-C₈), —O—CO-alkyl-(C₁-C₈), —N-alkyl₂-(C₁-C₈), —CHO, —SO₃H, —NH₂, —F, —Cl, —OH, —CF₃, —NO₂, and the radicals R^{1a} and R^{1b} being able to be linked to one another via covalent bonds, from a 1,3-butadiene-containing hydrocarbon stream.

The process of the invention can be used, in particular, for the work-up of telomerization mixtures which are obtained in the preparation of compounds of the formulae IIIa or IIIb,

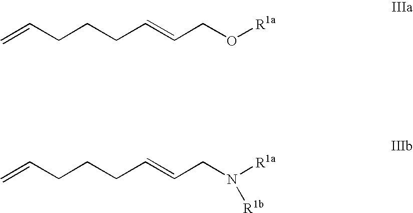

by reaction of 1,3-butadiene with a nucleophile (VII) of one of the formulae VIIa, VIIb or VIIc

R^{1a}—O—H VIIa

(R^{1a})(R^{1b})N—H VIIb

R^{1a}—COOH VIIc

where R^{1a} and R^{1b} are as defined above.

Particular preference is given to preparing compounds of the formula II in which X is OR^{1a} or NR^{1a}R^{1b} and

R^{1a} is H, methyl, ethyl, n-propyl, isopropyl, tert-butyl, n-butyl, sec-butyl, pentyl, hexyl, heptyl, octyl, octenyl, octadienyl, isononyl, 2-ethylhexyl, n-nonyl, phenyl, m-, o- or p-methylphenyl, naphthyl, 2,4-di-tert-butylphenyl, 2,6-di-tert-butylmethylphenyl, hydrogencarbonyl, methylcarbonyl, ethylcarbonyl, propylcarbonyl or phenylcarbonyl and/or R^{1b} is H, methyl, ethyl, n-propyl, isopropyl, tert-butyl, n-butyl, sec-butyl, pentyl, hexyl, heptyl, octyl, octenyl, octadienyl, isononyl, 2-ethylhexyl, n-nonyl, phenyl, m-, o- or p-methylphenyl, naphthyl, 2,4-di-tert-butylphenyl, 2,6-di-tert-butylmethylphenyl, hydrogencarbonyl, methylcarbonyl, ethylcarbonyl, propylcarbonyl or phenylcarbonyl, by means of the telomerization. Very particular preference is given to preparing a compound of the formula IIIa in which R^{1a}=hydrogen, methyl, ethyl, phenyl or methylcarbonyl by means of the process of the invention. The compounds of the formulae IIa and IIIb can be present either in the cis form or in the trans form.

The telomerization is very particularly preferably used to prepare a 2,7-octadienyl derivative, in particular 1-methoxyocta-2,7-diene from which 1-octene can be prepared by hydrogenation of the two double bonds and subsequent elimination of methanol.

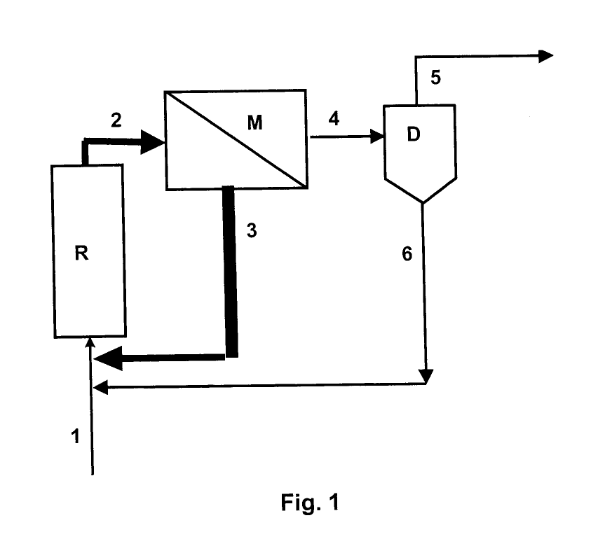

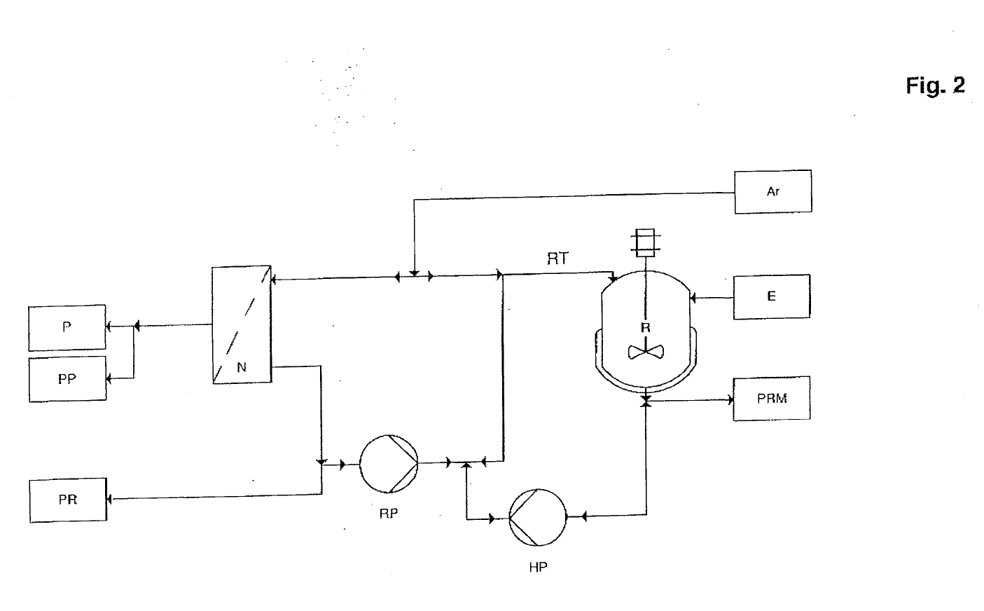

The present invention is described by way of example with the aid of FIGS. 1 and 2, without the invention being restricted to this embodiment.

FIG. 1 schematically shows an embodiment of the process of the invention. In this embodiment, the reactants 1 of the telomerization and a recycle stream 6 are fed into the reactor R in which the telomerization takes place. The reactor can be a stirred vessel or a tube reactor. The telomerization mixture 2 is fed directly to the membrane M. The retentate stream 3 obtained at the membrane is recirculated to the reaction. The permeate stream 4 obtained at the membrane M is passed to a thermal separation apparatus D, e.g. a thin film evaporator. In this, the permeate is separated into telomerization product and any unreacted olefins which leave the thermal separation apparatus as stream 5 and a stream 6 which contains the high boilers and complex catalyst and/or free ligands which have not been separated off in the membrane separation and is recirculated to the reactor R.

FIG. 2 schematically shows the process carried out in the experimental plant as used in Example 1. The process comprises a reaction in the reactor R with installed stirrer and a nanofiltration N. The entire plant can be flushed with argon AR and made oxygen-free. For the reaction, the starting mixture E, which contains palladium compound and ligand, is placed in the reactor R and reacted. The reaction product is transferred to the nanofiltration N. From the nanofiltration, the permeate P which comprises predominantly reaction product is obtained at the membrane. The retentate RT obtained in the nanofiltration, which contains the catalyst and the ligand, is recirculated to the reactor. In this way, the catalyst/ligand mixture which has been separated off is concentrated.

A sample PRM for analysis of the reaction mixture obtained can be taken at the reactor outlet. The reaction mixture is conveyed by means of a high-pressure pump HP to a circuit which leads to the nanofiltration N. The recirculation pump RP ensures the necessary flow over the membrane. On the permeate side, the permeate P is taken off from the nanofiltration. A sampling facility for taking a sample of the permeate PP is present in the discharge line for the permeate P. A sample facility by means of which a sample of the retentate PR can be taken for analytical purposes is present in the discharge line for the retentate from the nanofiltration.

The following example illustrates the invention without restricting the scope, which is defined by the claims and the description.

### EXAMPLE 1

In an experimental plant as depicted in FIG. 2, the starting materials (E) for the telomerization reaction having the following composition were placed in the reactor after flushing with argon (Ar) to remove oxygen:
331.4 g of methanol
1170 g of C4 from a cracker (of which 511.2 g are 1,3-butadiene) (Oxeno Olefinchemie GmbH)
0.1040 g of palladium acetylacetonate (Umicore)
0.7658 g of 1,3-dimesitylimidazolium chloride (Degussa A G)
7.6 g of sodium methoxide (Aldrich)
13.42 g of o-cresol (Aldrich)
200.8 g of tripropylene glycol (Aldrich)

After all starting materials had been placed in the reactor at 80° C., the Pd catalyst with ligand (1,3-dimesitylimidazolium chloride) together with a residual amount (100 g) of methanol were added last and the reaction was thereby started. The course of the reaction was monitored by taking an hourly sample from the reactor and analyzing it by GC.

The reaction was stopped after 240 minutes by cooling to 25° C. The reaction product mixture containing the dissolved catalyst system was subsequently circulated via the nanofiltration unit (N). This was a unit which is fed via a high-pressure pump and builds up the necessary transmembrane pressure in the system. From there, the medium to be filtered goes via a recirculation pump to the membrane module “Memcell” from Osmota having an area of 80 cm². This module was fitted with a membrane of the type PDMS (6% radiation-crosslinked)-PPSU (polyphenylidene sulfoxide), GKSS, Geesthacht, over which the reaction product mixture was passed at 1.7 m/s and a transmembrane pressure of 30 bar. To prevent escape of gas, a pressure of 1.7 bar was set on the permeate side, which resulted in a pressure of 31.7 bar on the retentate side at a transmembrane pressure of 30 bar.

During circulation operation via the nanofiltration, permeate, which comprised predominantly reaction product, was taken from the system via the membrane. The catalyst and the ligand 1,3-dimesitylimidazolium chloride were largely retained by the membrane during this batch concentration and accumulated in the reactor (retentate). After all the reaction product had been concentrated in the reactor by the volumetric concentration factor of about 10 via the nanofiltration unit, the experiment was stopped.

The nanofiltration was studied in respect of permeate flow and retention of palladium. Table 1 shows the results of the experiments of Example 1.

TABLE 1
Results for Example 1

| | | | Pd, permeate |
|---|---|---|---|
| | | | [ppm] |
| | Stream | Main components [g], | Retention of |
| Process step | designation | Pd [ppm] | Pd (R) |
| Telo, start | Starting | 331.4 g of methanol | |
| | material | 511.2 g of 1,3-butadiene | |
| | | 0 g of 1-methoxy- | |
| | | 2,7-octadiene | |
| | | 21.1 ppm of Pd | |
| Telo, end | Reaction | 255.9 g of methanol | Pd, P 1.85 ppm |
| (=start | product to | 42.9 g of 1,3-butadiene | R, Pd 91% |
| of NF) | nanofiltration | 544.2 g of 1-methoxy- | |
| | (to NF) | 2,7-octadiene | |
| | | 20.6 ppm of Pd | |
| NF, end | Retentate from | 25.2 g of methanol | Pd, P 16.2 ppm |
| | nanofiltration | 41.9 g of 1,3-butadiene | R, Pd 90% |
| | | 54.6 g of 1-methoxy- | |
| | | 2,7-octadiene | |
| | | 160 ppm of Pd | |

The nanofiltration displayed a virtually constant membrane retention of about 90% for Pd at specific permeate fluxes of from 15 to 20 [g/m² h]. The balance over the total nanofiltration showed that 78.1% of the mass of palladium originally used remained in the retentate, while 21.9% of the mass of the Pd were taken from the system via the permeate. An exploratory experiment for further Pd retention by means of a second NF stage for after-treatment of the permeate mixture indicated that the Pd retention at the membrane was still 85% there.

1. A process for separating a metal complex catalyst from a reaction mixture obtained from a telomerization,
wherein
the metal complex catalyst is separated off at least one membrane.

2. The process as claimed in claim 1,
wherein
the membrane is selected from among membranes which are permeable to molecules having a molar mass of up to 1000 g/mol.

3. The process as claimed in claim 1,
wherein
the membrane is selected from among membranes which comprise, as separation-active layer, an alkali- and solvent-stable nanofiltration polymer layer of polyimides (PI), aromatic polyamides (PA), polyamidimides (PAI), polybenzimidazoles, acrylonitrileglycidyl methacrylate (PANGMA), polybenzimidazolones, polyacrylonitrile (PAN), polyaryl ether sulfones, polyesters, polyether ether ketones (PEEK), polycarbonates (PC), polytetrafluoroethylene, polybenzimidazole (PBI), polyvinylidene fluoride (PVDF), polypropylene (PP), polydimethylsiloxane (PDMS) or whose separation-active layer is made up of polymers having intrinsic microporosity (PIM) or whose separation-active layer is built up over a hydrophobicized ceramic membrane.

4. The process as claimed in claim 1,
wherein
two or more membranes are used.

5. The process as claimed in claim 1,
wherein
two or more membrane modules are used.

6. The process as claimed in claim 1,
wherein
the separation is carried out as a pressure-driven process.

7. The process as claimed in claim 1,
wherein
the membrane separation is carried out so that there is a pressure difference from the retentate side to the permeate side of at least 0.5 MPa.

8. The process as claimed in claim 1,
wherein
the process is carried out at a flow velocity over the membrane of from 0.1 to 15 m/sec.

9. The process as claimed in claim 1,
wherein
the volume flow ratio of the stream fed to the membrane in cross-current (fresh feed including the recirculated retentate) to permeate stream is 100-10 000:1.

10. The process as claimed in claim 1,
wherein
the metal complex catalyst which is separated off is recirculated to the telomerization.

11. The process as claimed in claim 1,
wherein
any free ligand selected from among organophosphorus or carbene ligand which is present in the reaction mixture is separated off at the membrane and recirculated to the telomerization.

12. The process as claimed in claim 1,
wherein
the molecular volume ratio of the organophosphorus or carbene ligand to the telomerization product is ≧1.5.

13. The process as claimed in claim 1,
wherein
the telomerization mixture is fed to the membrane under conditions which in terms of pressure and temperature (in ° C.) differ by not more than from 0 to 50% from the reaction conditions of the telomerization.

14. The process as claimed in claim 13,
wherein
the telomerization mixture is fed to the membrane at a pressure and/or a temperature which are/is from 0 to 30% lower than under the reaction conditions of the telomerization.

15. The process as claimed in claim 1,
wherein
a telomerization mixture which is obtained by telomerization of acyclic olefins having at least two conjugated double bonds with at least one nucleophile using a catalyst containing a metal of group 8, 9 or 10 of the Periodic Table of the Elements is used as reaction mixture from a telomerization.

16. The process as claimed in claim 1,
wherein
a telomerization mixture in which a palladium-carbene complex is present as metal complex catalyst is used.

17. The process as claimed in claim 16,
wherein
the ratio of carbene or organophosphorus ligand to metal [mol/mol] in the telomerization is from 0.01:1 to 250:1.

18. The process as claimed in claim 1,
wherein
water, alcohols, phenols, polyols, carboxylic acids, ammonia and/or primary or secondary amines are used as nucleophile (VII) in the telomerization.

19. The process as claimed in claim 1,
wherein
the separation is carried out at a temperature of from 80 to 100° C.

20. The process as claimed in claim 1,
wherein
the separation is carried out at a differential pressure of from 0.5 to 5 MPa.
